(19) United States
(12) Patent Application Publication
(10) Pub. No.: US 2009/0059197 A1
(43) Pub. Date: Mar. 5, 2009

(54) Exposure apparatus and method of exposing a semiconductor substrate

(76) Inventors: Dong-seok Nam, Yongin-si (KR); Byung-gook Kim, Seoul (KR); Seong-woon Choi, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/230,239

(22) Filed: Aug. 26, 2008

(30) Foreign Application Priority Data
Aug. 28, 2007 (KR) 10-2007-0086546

(51) Int. Cl. G03B 27/72

(52) U.S. Cl. 355/71; 355/67

(57) ABSTRACT

An exposure apparatus includes a light source adapted to emit light, a photomask in a path of the light between the light source and a semiconductor substrate, the photomask being in a mask plane (MP) and having patterns to be transcribed onto the semiconductor substrate, and a spatial light modulator (SLM) in a first image correction region of the photomask between the light source and the photomask, the SLM being adapted to adjust a distribution of intensity of the light.

### BACKGROUND

1. Field of the Invention

Embodiments of the present invention relate to manufacturing of semiconductor devices. More particularly, embodiments of the present invention relate to an exposure apparatus used in a photolithography process during manufacturing of a semiconductor device and to a method of exposing a semiconductor substrate using the exposure apparatus.

2. Description of the Related Art

A photolithography process may be used to form predetermined patterns on a semiconductor substrate. For example, patterns on a photomask may be transcribed onto a photoresist layer on the semiconductor substrate to form photoresist patterns on the semiconductor substrate, so the semiconductor substrate or a material layer thereon may be etched via the photoresist patterns to form the predetermined patterns. An exposure apparatus, e.g., a scanner, a stepper, and so forth, may be used to transcribe the patterns of the photomask onto the photoresist layer.

### SUMMARY OF THE INVENTION

According to example embodiments of the present invention, there is provided an exposure apparatus, including a light source adapted to emit light, a photomask in a path of the light between the light source and a semiconductor substrate, the photomask being in a mask plane (MP) and having patterns to be transcribed onto the semiconductor substrate, and a spatial light modulator (SLM) in a first image correction region of the photomask between the light source and the photomask, the SLM being adapted to adjust a distribution of intensity of the light.

The first image correction region may extend to a first distance from a conjugate plane (CP) of the MP along a first direction and to a second distance from the CP of the MP along the second direction, each of the first and second distances being substantially equal to a thickness of the photomask, the first direction being opposite the second direction, the first and second directions being perpendicular to the CP. The semiconductor substrate may be in a second image correction region of the photomask, the second image correction region of the photomask being different than the first image correction region of the photomask. The SLM may include a micromirror array adapted to reflect light delivered from the light source. The micromirror array may include a plurality of micromirrors, each micromirror of the plurality of micromirrors being adapted to adjust an angle thereof with respect to a surface supporting the micromirror array. The apparatus may further include a polarization beam splitter (PBS) between the photomask and the SLM, the PBS being adapted to reflect light delivered from the light source toward the SLM.

The exposure apparatus may further include a first quarter wavelength (λ/4) plate between the PBS and the SLM. The exposure apparatus may further include an aperture between the PBS and the SLM. The exposure apparatus may further include a first lens between the PBS and the SLM, the first lens being adapted to collimate from the PBS in. The exposure apparatus may further include a second lens between the first lens and the SLM, the second lens being adapted to focus light from the first lens. The exposure apparatus may further include a third lens between the second lens and the SLM, the third lens being adapted to collimate light from the second lens. The exposure apparatus may further include a micro-fly's eye lens in the path of the light between the light source and the PBS. The exposure apparatus may further include a beam delivery module between the light source and the PBS. The exposure apparatus may further include a second quarter wavelength (λ/4) plate between the PBS and the photomask. The exposure apparatus may further include a fourth lens between the PBS and the photomask, the fourth lens being adapted to collimate light from the PBS.

According to example embodiments of the present invention, there is provided an exposure apparatus, including a light source adapted to emit light, a photomask in a path of the light between the light source and a semiconductor substrate, the photomask having patterns to be transcribed onto the semiconductor substrate, and a uniformity adjustment module between the light source and the photomask, the uniformity adjustment module including a PBS and a SLM, the PBS being adapted to reflect light delivered from the light source toward the SLM, and the SLM being adapted to adjust a distribution of intensity of the light. The SLM may be in a first image correction region of the photomask between the light source and the photomask. The semiconductor substrate may be in a second image correction region of the photomask, the second image correction region of the photomask being different than the first image correction region of the photomask.

According to example embodiments of the present invention, there is provided a method of exposing a substrate, including positioning a SLM in a first image correction region of a photomask, reflecting substantially all light from a light source toward the SLM via a PBS, reflecting substantially all the emitted light toward a SLM via a PBS, adjusting a distribution of intensity of the light via the SLM, and directing the light from the SLM to a semiconductor substrate through a photomask, the photomask having patterns to be transcribed onto the semiconductor substrate

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a schematic cross-sectional view of an exposure apparatus according to an embodiment of the present invention;

FIG. 2 illustrates a perspective view of a micro-fly's eye lens of the exposure apparatus of FIG. 1;

FIG. 3 illustrates a perspective view of a SLM of the exposure apparatus of FIG. 1; and

FIG. 4 illustrates a flowchart of a method of exposing a semiconductor substrate according to an embodiment of the present invention.

### DETAILED DESCRIPTION OF THE INVENTION

Korean Patent Application No. 10-2007-0086546, filed on Aug. 28, 2007, in the Korean Intellectual Property Office, and entitled: “Exposure Apparatus and Method of Exposing Semiconductor Substrate,” is incorporated by reference herein in its entirety.

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers, elements, and regions may be exaggerated for clarity of illustration. It will also be understood that when a layer or element is referred to as being “on” another layer, element, or substrate, it can be directly on the other layer, element, or substrate, or intervening layers and/or elements may also be present. Further, it will also be understood that when a layer or element is referred to as being “between” two layers or elements, it can be the only layer or element between the two layers or elements, or one or more intervening layers and/or elements may also be present. In addition, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like reference numerals refer to like elements throughout.

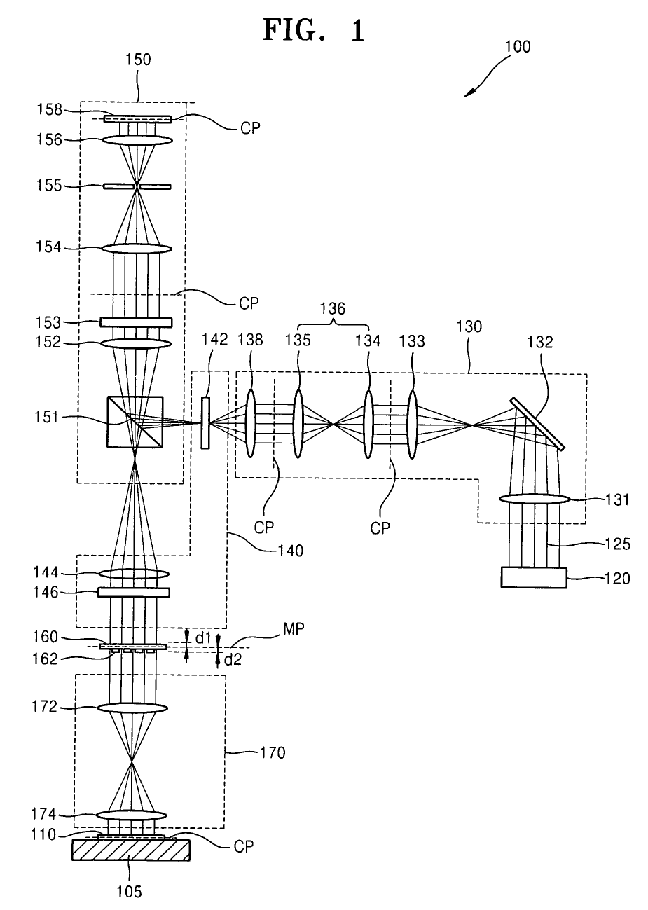

FIG. 1 illustrates a schematic cross-sectional view of an exposure apparatus 100 according to an embodiment of the present invention. Referring to FIG. 1, the exposure apparatus 100 may include a light source 120 emitting light 125, a beam delivery module 130, a condensing module 140, a uniformity adjustment module 150, and a projection module 170. A path of the light 125 is illustrated by lines between respective elements in FIG. 1.

In particular, as illustrated in FIG. 1, the light 125 may be relayed to a proper illumination system from the beam delivery module 130, and may be delivered to the uniformity adjustment module 150 via a first portion of the condensing module 140. Then, the light 125 may be delivered from the uniformity adjustment module 150 via a second portion of the condensing module 140 to be irradiated on a semiconductor substrate 110 through the photomask 160 and the projection module 170. Irradiation of the light 125 on the semiconductor substrate 110 through the photomask 160, may transcribe patterns 162 of the photomask 160 onto a photoresist layer (not shown) on the semiconductor substrate 110 to form a photoresist pattern (not shown). The semiconductor substrate 110 may be seated on a stage 105. When the exposure apparatus 100 is of a scanner type, the stage 105 may be moved precisely during an exposure process.

The light source 120 may be any suitable light source. For example, the light source may be a laser source, so the emitted light 125 may be linearly polarized light. The light 125 emitted from the light source 120 may be collimated. It is noted, however, that other types of light 125, e.g., the light 125 emitted from the light source 120 may be uncollimated, e.g., may be diverging or converging, are within the scope of the present invention.

The uniformity adjustment module 150 may be used to correct the CD non-uniformity of the patterns 162 of the photomask 160. Accordingly, the uniformity adjustment module 150 may include a unit for controlling intensity of light 125 irradiated from the uniformity adjustment module 150 toward the photomask 160 and a unit for controlling transmission and polarization of the light 125 delivered into and out of the uniformity adjustment module 150. For example, the uniformity adjustment module 150 may include a spatial light modulator (SLM) 158 for adjusting the intensity of the light 125 delivered from the light source 120 and for adjusting a reflection angle of the light 125 from the SLM 158 toward the second portion of the condensing module 140. The uniformity adjustment module 150 may further include a polarized beam splitter (PBS) 151 between the photomask 160 and the SLM 158 to reflect the linearly polarized light 125 delivered from the light source 120 toward the SLM 158. The PBS 151 may reflect the light 125 or transmit the light 125 according to the polarization of the light 125.

The uniformity adjustment module 150 may further include a plurality of lenses and a quarter wavelength (λ/4) plate. For example, a first lens 152 may be disposed between the PBS 151 and the SLM 158, so light diverging reflected by the PBS 151 toward the first lens 152 may be collimated by the first lens 152. In other words, the first lens 152 may be a collimating lens.

A first quarter wavelength (λ/4) plate 153 may be disposed between the first lens 152 and the SLM 158. Therefore, linearly polarized light 125 gathered by the first lens 152 may be transformed into circularly polarized light after passing through the first quarter wavelength (λ/4) plate 153.

A second lens 154 may be disposed between the first lens 152 and the SLM 158, and an aperture 155 may be disposed between the second lens 154 and the SLM 158. For example, the aperture 155 may be positioned at the focal point of the second lens 154. As such, the circularly polarized light 125 may pass through the second lens 154 and may be focused to pass through the aperture 155.

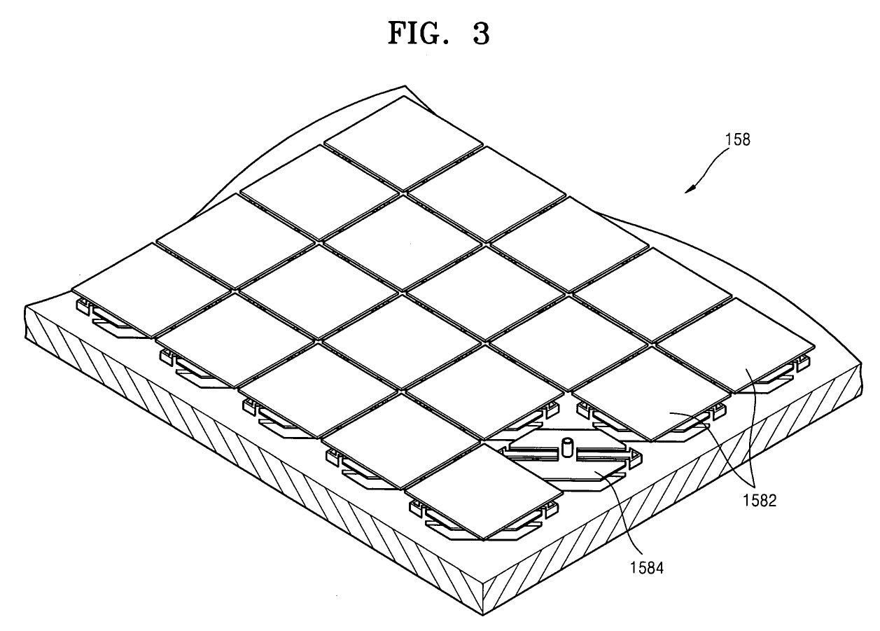

A third lens 156 may be disposed between the aperture 155 and the SLM 158. As such, light 125 passing through the aperture 155 may be collimated by the third lens 156, i.e., collimated light may be incident on the SLM 158. Thus, intensity of light 125 delivered into the SLM 158 may be adjusted by the SLM 158, so the adjusted light 125 may be reflected toward the photomask 160. A detailed structure of the SLM 158 and its operation will be described in more detail below with reference to FIG. 3.

The light 125 reflected from the SLM 158 toward the photomask 160 may pass through the third lens 156, the aperture 155, the second lens 154, and the first quarter wavelength (λ/4) plate 153. In particular, the light 125 reflected away from the SLM through the first quarter wavelength (λ/4) plate 153 may have a difference of about 90° in its polarization direction as compared to the light 125 directed toward the SLM when passing the first quarter wavelength (λ/4) plate 153. Accordingly, substantially all the light 125 reflected from the SLM 158 toward the photomask 160 may be transmitted through the PBS 151. In other words, when the light 125 is delivered from the light source 120 to the SLM 158, substantially all the light 125 may be reflected from the PBS 151 toward the SLM 158, while when the light 125 is reflected away by the SLM 158, the light 125 may be polarized at a 90° angle to be substantially entirely transmitted through the PBS 151 toward the condensing module 140.

The condensing module 140 may include the first and second portions. The first portion of the condensing module 140 may deliver the light 125 from the beam delivery module 130 to the uniformity adjustment module 150. The second portion of the condensing module 140 may deliver the light 125 from the uniformity adjustment module 150, i.e., light 125 with an adjusted intensity distribution, to the photomask 160.

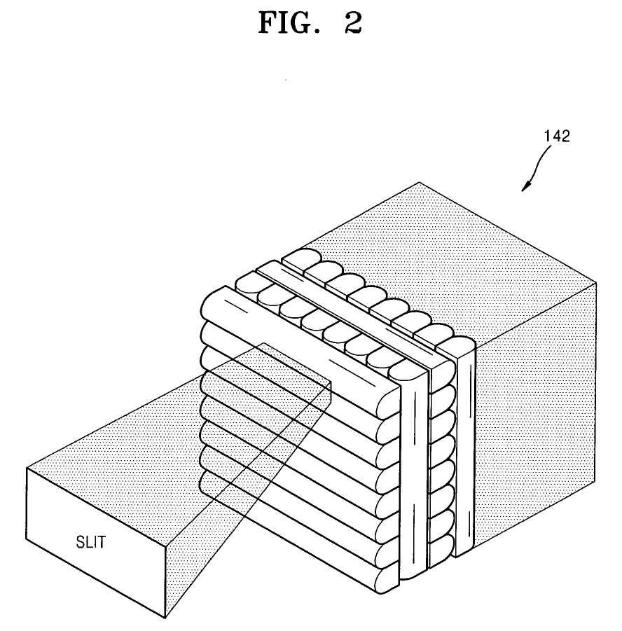

For example, the first portion of the condensing module 140 may include a micro-fly's eye lens 142 to deliver the light 125 from the beam delivery module 130 to the uniformity adjustment module 150. The micro-fly's eye lens 142 may distribute the light 125 delivered by the beam delivery module 130 in an exposure slit region, as illustrated in FIG. 2. The micro-fly's eye lens 142 may be designed to include features of off-axis illumination. The light 125 distributed in the exposure slit region by the micro-fly's eye lens 142 may be delivered to the PBS 151 of the uniformity adjustment module 150.

In another example, the second portion of the condensing module 140 may include a fourth lens 144 and a second quarter wavelength (λ/4) plate 146 to deliver the light 125 from the uniformity adjustment module 150 to the photomask 160. The fourth lens 144 may gather the light 125 transmitted through the PBS 151 in parallel rays. The second quarter wavelength (λ/4) plate 146 may transform the light 125 to have circular polarization, and may deliver the circularly polarized light 125 to the photomask 160. The light 125 that has passed through the photomask 160 may be irradiated on the semiconductor substrate 110 through the projection module 170, e.g., the projection module 170 may include a tenth lens 172 and an eleventh lens 174.

It is noted that if a transverse electric field (TE) mode is used, the second quarter wavelength (λ/4) plate 146 may be omitted, so linearly polarized light 125 may be irradiated on the photomask 160. In this case, the exposure apparatus 100 may be designed to use the linearly polarized light 125. For example, quarter wavelength polarization or half wavelength polarization may be selected using a rotatable plate.

The beam delivery module 130 may deliver the light 125 emitted from the light source 120 to the micro-fly's eye lens 142. For example, a fifth lens 131 may condense the light 125 emitted from the light source 120 on a mirror 132. The light 125 reflected by the mirror 132 may be collimated by a sixth lens 133. Subsequently, the light 125 may pass through a seventh lens 134, and may pass through focus before incident as diverging light on an eighth lens 135, which may collimate the light 125. A combination of the seventh lens 134 and the eighth lens 135 may be referred to as a relay optic. Next, the light 125 may be focused by a ninth lens 138 onto the micro-fly's eye lens 142.

A detailed description of positioning the SLM 158 is as follows. The SLM 158 may be disposed in an image correction region of the photomask 160. The semiconductor substrate 110 may be positioned on another image correction region of the photomask 160. Thus, the SLM 158 may be disposed on an image correction region of a plane on which the semiconductor substrate 110 is positioned. An image correction region of the photomask 160 may be on a conjugate plane (CP) of a mask plane (MP) of the photomask 160.

In particular, a plane on which the photomask 160 is positioned may be defined as the MP. Accordingly, an image plane of the MP may be defined as the CP of the MP. For example, in FIG. 1, each CP of the MP indicates an ideal surface. However, since in implementation it may be difficult to dispose an element, e.g., the SLM 158, on a precisely-defined two-dimensional plane, the image correction region of the photomask 160 may be defined as a an extended plane including the CP of the MP and an additional region on each side of the CP. More specifically, the correction region may extend to a first distance d1 from the CP of the MP along a first direction and to a second distance d2 from the CP of the MP along the second direction, each of the first and second distances being substantially equal to a thickness of the photomask 160, and the first direction being opposite the second direction and perpendicular to the CP. In other words, while the image correction region may extend to a substantially same length as the CP, the image correction region may shift relative to the CP in a direction perpendicular to a length of the CP by the thickness of the photomask 160. For example, as illustrated in FIG. 1, the image correction region may include a CP extended to a plane within a range of the width of the photomask 160 along a direction intersecting collimated light 125, i.e., as opposed to having a CP in an ideal focusing plane.

When the SLM 158 is positioned in the image correction region according to embodiment of the present invention, a predetermined width of the SLM 158 may substantially equal the width of the photomask 160. As such, when the CD of a predetermined portion of the photomask 160 is corrected, the reflection angle of a corresponding portion of the SLM 158 may be adjusted to correspond to and be incident on the predetermined portion of the photomask 160 being corrected. The corresponding relationship between the SLM 158 and the photomask 160 may allow the CD uniformity of the patterns 162 of the photomask 160 be corrected very easily using the SLM 158. As such, the CD uniformity of the photoresist patterns (not shown) formed on the semiconductor substrate 110 may be substantially increased. In contrast to embodiments of the present invention, failure to position the SLM in the image correction region of the photomask 160 may cause the width of the SLM 158 be larger than that of the photomask 160, so light reflected from the SLM 158 toward the photomask 160 may not be incident on a portion of the photomask 160 requiring correction of the CD. As such, ability and reliability of correcting the CD of the photomask 160 using a SLM positioned outside the image correction region may be substantially lowered.

FIG. 3 illustrates a perspective view of the SLM 158. Referring to FIG. 3, the SLM 158 may include a plurality of micromirrors 1582 arranged, e.g., in a matrix form, to cover a wide range, i.e., a large surface area. The micromirrors 1582 may be positioned in close proximity to each other, and each of the micromirrors 1582 may be adjusted, e.g., angle thereof with respect to a surface supporting the micromirrors 1582, using a driver 1584 disposed under the micromirrors 1582. The driver 1584 may separately control angles of each micromirror 1582, so predetermined micromirrors 1582, i.e., micromirrors 1582 corresponding to positions in the photomasks 160, may be selected and operated to adjust intensity of light, e.g., according to positioned of the micromirrors 1582, reflected toward the photomask 160.

Since the SLM 158 may include a large number of micromirrors 1582 distributed over a wide range, the predetermined micromirrors 1582 of the SLM 158 may be easily selected and operated to correspond to any positions within the photomask 160. For example, even if the photomask 160 is modified, the number and distribution of the micromirrors 1582 in the SLM 158 may be sufficient to accurately reflect light toward required positions in the photomask 160, and the SLM 158 may not require replacement. In another example, even if the photomask 160 moves, e.g., if the exposure apparatus 100 is a scanner system, corresponding micromirrors 1582 in the SLM may be selected and operated without physically moving the SLM 158. Thus, a single SLM 158 may be used in various types of the photomask 160, and the exposure apparatus 100 may be easily applied to any system, e.g., a stepper, a scanner system, a next-generation extreme ultraviolet (EUV) system, and so forth. The SLM 158 may be referred to as a micromirror array or a micromirror device.

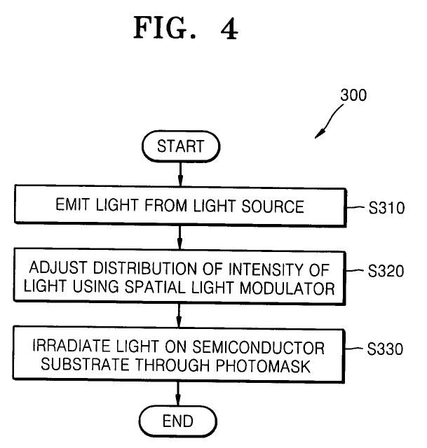

FIG. 4 illustrates a flowchart for explaining a method 300 of exposing a semiconductor substrate according to an embodiment of the present invention. Referring to FIGS. 1 and 4, the light 125 may be emitted from the light source 120 (S310). For example, as illustrated in FIG. 1, the light 125 may be emitted in parallel rays that are linearly polarized. In another example, the light 125 may be emitted in divergent rays.

Subsequently, the SLM 158 may adjust distribution of the intensity of the light 125 (S320). Before adjusting distribution of the intensity of the light, the light 125 delivered from the light source 120 may be passed through the micro-fly's eye lens 142 and distributed in an exposure slit region. For example, as illustrated in FIG. 1, the light 125 emitted from the light source 120 may be delivered to the PBS 151 through the beam delivery module 130 and the micro-fly's eye lens 142, and may be reflected substantially entirely from the PBS 151 toward the SLM 158. Subsequently, the light 125 may be delivered to the SLM 158 through the first lens 152, the first quarter wavelength (λ/4) plate 153, the second lens 154, the aperture 155, and the third lens 156. The SLM 158 may adjust the distribution of the intensity of the light 125 using tilts of the micromirrors 1582.

Subsequently, as illustrated in FIG. 1, the light 125 adjusted by the tilts of the micromirrors 1582 of the SLM 158 may be reflected from the SLM 158 toward the PBS 151 through the third lens 156, the aperture 155, the second lens 1534, the first quarter wavelength (λ/4) plate 153, and the first lens 152. The light 125 polarized at about 90° angle in the first quarter wavelength (λ/4) plate 153 may be transmitted substantially entirely through the PBS 151, and may be delivered to the condensing module 140.

Subsequently, the light 125 may pass through the photomask 160, and may be irradiated on the semiconductor substrate 10 (S330). For example, as illustrated in FIG. 1, the light 125 may pass through the fourth lens 144 and the second quarter wavelength (λ/4) plate 146 of the condensing module 140 to be incident on the photomask 160. As described previously, when a TE mode is used, the light 125 may be delivered directly to the photomask 160 from the fourth lens 144. The light 125 may be diffracted according to the pattern 162 of the photomask 160, and may pass through the projection module 170 to be reduced to a predetermined intensity. The light 125 from the projection nodule may be irradiated on the semiconductor substrate 110. Since the light 125 irradiated on the semiconductor substrate 110 may be adjusted by adjusting tilts of micromirrors 1582, the resultant reflected light may correct CD uniformity on the semiconductor substrate 110, i.e., the SLM 158 may be adjusted to correct uniformity of the patterns of the photomask 160.

As such, the light 125 irradiated on the semiconductor substrate 110 may deliver light energy to a photoresist layer (not shown) on the semiconductor substrate 110. Subsequently, when the semiconductor substrate 110 is developed, photoresist patterns may be formed on the semiconductor substrate 110. When the semiconductor substrate 110 is etched using the photoresist patterns as an etch-protective layer, patterns having predetermined shapes can be formed on the semiconductor substrate 110.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An exposure apparatus, comprising:
a light source adapted to emit light;
a photomask in a path of the light between the light source and a semiconductor substrate, the photomask being in a mask plane (MP) and having patterns to be transcribed onto the semiconductor substrate; and
a spatial light modulator (SLM) in a first image correction region of the photomask between the light source and the photomask, the SLM being adapted to adjust a distribution of intensity of the light.

2. The exposure apparatus as claimed in claim 1, wherein the first image correction region extends to a first distance from a conjugate plane (CP) of the MP along a first direction and to a second distance from the CP of the MP along the second direction, each of the first and second distances being substantially equal to a thickness of the photomask, the first direction being opposite the second direction, the first and second directions being perpendicular to the CP.

3. The exposure apparatus as claimed in claim 1, wherein the semiconductor substrate is in a second image correction region of the photomask, the second image correction region of the photomask being different than the first image correction region of the photomask.

4. The exposure apparatus as claimed in claim 1, wherein the SLM includes a micromirror array adapted to reflect light delivered from the light source.

5. The exposure apparatus as claimed in claim 4, wherein the micromirror array includes a plurality of micromirrors, each micromirror of the plurality of micromirrors being adapted to adjust an angle thereof with respect to a surface supporting the micromirror array.

6. The exposure apparatus as claimed in claim 1, further comprising a polarization beam splitter (PBS) between the photomask and the SLM, the PBS being adapted to reflect light delivered from the light source toward the SLM.

7. The exposure apparatus as claimed in claim 6, further comprising a first quarter wavelength (λ/4) plate between the PBS and the SLM.

8. The exposure apparatus as claimed in claim 6, further comprising an aperture between the PBS and the SLM.

9. The exposure apparatus as claimed in claim 6, further comprising a first lens between the PBS and the SLM, the first lens being adapted to collimate from the PBS in.

10. The exposure apparatus as claimed in claim 9, further comprising a second lens between the first lens and the SLM, the second lens being adapted to focus light from the first lens.

11. The exposure apparatus as claimed in claim 10, further comprising a third lens between the second lens and the SLM, the third lens being adapted to collimate light from the second lens.

12. The exposure apparatus as claimed in claim 6, further comprising a micro-fly's eye lens in the path of the light between the light source and the PBS.

13. The exposure apparatus as claimed in claim 12, further comprising a beam delivery module between the light source and the PBS.

14. The exposure apparatus as claimed in claim 6, further comprising a second quarter wavelength (λ/4) plate between the PBS and the photomask.

15. The exposure apparatus as claimed in claim 6, further comprising a fourth lens between the PBS and the photomask, the fourth lens being adapted to collimate light from the PBS.

16. An exposure apparatus, comprising:
a light source adapted to emit light;
a photomask in a path of the light between the light source and a
semiconductor substrate, the photomask having patterns to be transcribed onto the semiconductor substrate; and
a uniformity adjustment module between the light source and the photomask, the uniformity adjustment module including a polarization beam splitter (PBS) and a spatial light modulator (SLM), the PBS being adapted to reflect light delivered from the light source toward the SLM, and the SLM being adapted to adjust a distribution of intensity of the light.

17. The exposure apparatus as claimed in claim 16, wherein the SLM is in a first image correction region of the photomask between the light source and the photomask.

18. The exposure apparatus as claimed in claim 17, wherein the semiconductor substrate is disposed in a second image correction region of the photomask, the second image correction region of the photomask being different than the first image correction region of the photomask.
